(19) United States
(12) Patent Application Publication
(10) Pub. No.: US 2025/0380123 A1
(43) Pub. Date: Dec. 11, 2025

(54) TWO-WHEELED VEHICLE CRASH DETECTION ON MOBILE DEVICE

(71) Applicant: Apple Inc., Cupertino, CA (US)

(72) Inventors: Vinay R. Majjigi, Mountain View, CA (US); Bharath Narasimha Rao, San Mateo, CA (US); Aditya Sarathy, Santa Clara, CA (US); Alvaro J. Melendez Hasbun, San Francisco, CA (US); Aniket Aranake, San Jose, CA (US); Atahar K. Mostafa, Benicia, CA (US); David Ojeda Avellaneda, San Francisco, CA (US); Ethan Goolish, Mountain View, CA (US); Jessica Y. Yip, Menlo Park, CA (US); Jiajie Xu, San Jose, CA (US); Manasi Deshpande, San Jose, CA (US); Ming Ying Yang, San Clara, CA (US); Mrinal Agarwal, San Jose, CA (US); Omar Aziz, Santa Clara, CA (US); Parisa Dehleh Hossein Zadeh, San Jose, CA (US); Paul D. Bryan, San Jose, CA (US); Rebecca L. Clarkson, San Francisco, CA (US); Sriram Venkateswaran, Sunnyvale, CA (US); Sunny K. Chow, Santa Clara, CA (US); Suresh B. Malakar, San Jose, CA (US); Tejal Bhamre, Mountain View, CA (US); Tianye Sun, Sunnyvale, CA (US); Umamahesh Srinivas, Milpitas, CA (US); Vineel Kumar Reddy Yettella, Sunnyvale, CA (US)

(21) Appl. No.: 19/231,399

(22) Filed: Jun. 6, 2025

Related U.S. Application Data
(60) Provisional application No. 63/657,720, filed on Jun. 7, 2024.

(51) Int. Cl. H04W 4/90; G01P 1/07; G01P 15/18; G04G 21/02; G10L 25/51

(52) U.S. Cl. CPC H04W 4/90; G01P 1/07; G01P 15/18; G04G 21/02; G10L 25/51

(57) ABSTRACT

Embodiments are disclosed for crash detection on one or more mobile devices (e.g., smartwatch and/or smartphone). In some embodiments, a method comprises: detecting, with at least one processor, a motorcycle crash event on a crash device; extracting, with the at least one processor, multimodal features from sensor data generated by multiple sensing modalities of the crash device; computing, with the at least one processor, a plurality of crash decisions based on a plurality of machine learning models applied to the multimodal features; and determining, with the at least one processor, that a motorcycle crash has occurred involving the crash device based on the plurality of crash decisions and a severity model.

### CROSS-REFERENCE TO RELATED APPLICATION

This application claims priority to U.S. Provisional Patent Application No. 63/657,720, filed Jun. 7, 2024, the entire contents of which are incorporated herein by reference.

### TECHNICAL FIELD

This disclosure relates generally to using a mobile device to detect when a user has been in an accident while riding a two-wheeled vehicle.

### BACKGROUND

When a motorcycle rider is injured or otherwise incapacitated in an accident, the rider may be unable to use their mobile phone to call for emergency assistance. This is particularly dire if the accident occurs in a location where there are no bystanders who can assist the rider.

### SUMMARY

Embodiments are disclosed for motorcycle crash detection on one or more crash devices (e.g., smartwatch, smartphone etc.). In some embodiments, a method comprises: detecting, with at least one processor, a motorcycle crash event on a crash device; extracting, with the at least one processor, multimodal features from sensor data generated by multiple sensing modalities of the crash device; computing, with the at least one processor, a plurality of crash decisions based on a plurality of machine learning models applied to the multimodal features; and determining, with the at least one processor, that a motorcycle crash has occurred involving the crash device based on the plurality of crash decisions and a severity model.

In some embodiments, the method further comprises responsive to a motorcycle crash being determined, presenting a notification on a screen of the crash device requesting a response from a user of the crash device.

In some embodiments, the method further comprises determining whether the crash device is stationary for a predetermined period of time; responsive to the crash device being stationary for the predetermined period of time, starting a timer or counter; determining that the timer or counter meets a threshold time or count, respectively; and escalating the notification.

In some embodiments, the method further comprises determining, as a result of the escalating, that no response to the notification was received after the threshold time or count was met, automatically contacting emergency services using one or more communication modalities of the crash device.

In some embodiments, the method comprises: sending, to a network server computer, at least one of the multimodal features, crash decisions, inference of a severe crash or user interactions with the notification; receiving, from the network server, at least one update to at least one parameter of at least one machine learning model or the severity model; and updating, with the at least one processor, the at least one parameter with the at least one update.

In some embodiments, at least one of the multimodal features is user orientation data captured by at least one rotation sensor of the crash device.

In some embodiments, at least one of the multimodal features is impact data as the user hits the ground captured by at least one accelerometer of the crash device.

In some embodiments, at least one of the multimodal features is a deceleration pulse signature present in acceleration data.

In some embodiments, at least one of the multimodal features is sound pressure level of audio data captured by at least one microphone of the crash device.

In some embodiments, at least one of the multimodal features is a drop in speed of the crash device.

In some embodiments, wherein the at least two multimodal features are processed over two different time windows having different time lengths.

In some embodiments, detecting a motorcycle crash event on a crash device includes distinguishing between a vehicle crash and a motorcycle crash based on a level of ambient audio captured by a microphone of the crash device.

In some embodiments, a level of wind noise in the ambient audio and at least one other crash detection feature are used to distinguish between the vehicle crash and the motorcycle crash.

In some embodiments, detecting a motorcycle crash event on a crash device includes distinguishing between on-road and off-road motorcycle riding.

In some embodiments, the method further comprises matching epochs for the multimodal features with epochs for the additional multimodal features to remove misalignment between epoch boundaries.

Other embodiments are directed to an apparatus, system and computer-readable medium.

Particular embodiments described herein provide one or more of the following advantages. The disclosed motorcycle crash detection embodiments allow a crash device (e.g., smartphone, smartwatch etc.) to automatically detect when a user is in a motorcycle accident, while also reducing the occurrence of false crash detections. If a crash is detected, the crash device presents a user interface that alerts the user for a period of time. If the user is responsive, they can swipe the screen or provide other input to call emergency services immediately or dismiss the alert if the user does not need emergency services. If after the time period expires there is no user interaction with the crash device, a countdown starts. When the countdown ends, emergency services and/or the user's emergency contact list are automatically contacted via a phone call or text message.

### BRIEF DESCRIPTION OF THE DRAWINGS

FIG. 1 illustrates a smartwatch for motorcycle crash detection, according to one or more embodiments.

FIG. 2 is a motorcycle crash detection timeline, according to one or more embodiments.

FIG. 3 is a block diagram of a motorcycle crash detection system, according to one or more embodiments.

FIG. 4 is a system diagram illustrating the detection of motorcycle crashes, according to one or more embodiments.

FIG. 5 is a system diagram illustrating the use of sensor data to trigger motorcycle crash detection on an application processor, according to one or more embodiments.

FIG. 6 is a flow diagram illustrating the use of audio to identify motorcycles, according to one or more embodiments.

FIG. 7 is a flow diagram illustrating differentiating behaviors from on-road and off-road motorcycle riding based on high dynamics rotation data, according to one or more embodiments.

FIG. 8 is a flow diagram illustrating a self-monitoring process 900, according to one or more embodiments.

FIG. 9 is a flow diagram illustrating cascaded process behavior, according to one or more embodiments.

FIG. 10 is a flow diagram illustrating a process self-monitoring for motorcycle crash detection, according to one or more embodiments.

FIG. 11 is a flow diagram illustrating a process of process self-monitoring for motorcycle crash detection, according to one or more embodiments.

FIG. 12 is a flow diagram of a process for motorcycle crash detection, as described in reference to FIGS. 1-11.

FIG. 13 is a block diagram of a device architecture for implementing the features and processes described in reference to FIGS. 1-12.

### DETAILED DESCRIPTION

### Overview

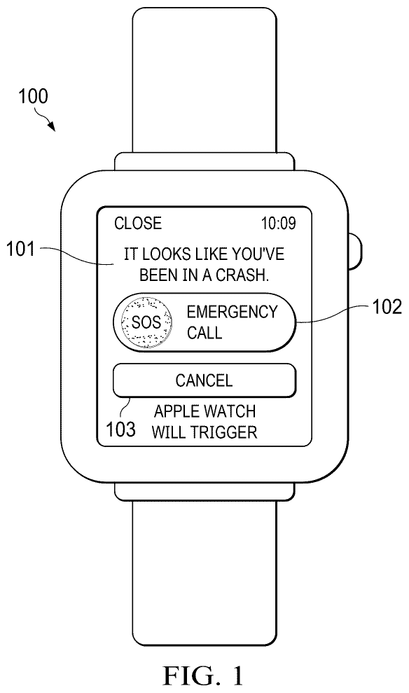

FIG. 1 illustrates an example crash device, a smartwatch 100, for motorcycle crash detection, according to one or more embodiments. Other examples of crash devices include a smartphone and tablet computer. The disclosed crash detection embodiments allow a crash device, such as smartwatch 100, to detect when a user is in a motorcycle crash, while also reducing the occurrence of false crash detections. The description that follows refers to motorcycle crash detection. However, the techniques of motorcycle crash detection can be extended to any two-wheeled vehicle or other open-air transportation, including but not limited to: motorcycles, mopeds, electric/non-electric bicycles, scooters, jet skis, snow mobiles, riding a horse or any other mode of transportation where the rider and the crash device can be decoupled from the mode of transportation during a crash.

Motorcycle detection differs from car crash detection because the crash device (smartwatch or mobile device) is typically attached to the user (e.g., in their pocket) rather than attached to the vehicle, such as in a vehicle crash. This suggests a greater reliance on rotation and loss of balance rather than acceleration impact. Also, some sensing modalities are not as useful for motorcycle crashes, such as sensing airbag deployment using a barometer.

In some embodiments, if a motorcycle crash is detected, smartwatch 100 presents user interface (UI) 101 with a wellness check for a predetermined time period. If the user is responsive, the user can swipe “SOS Emergency Call” affordance 102 to contact emergency services, or touch “Cancel” affordance 103 to cancel the alert. If, however, after the predetermined time period expires the user is unresponsive (e.g., there is no user interaction with UI 101), a countdown timer starts (e.g., counting down from 10). When the countdown ends, emergency services and/or the user's emergency contact list is automatically contacted through one or more communication modalities (e.g., via a phone call or text message).

In some embodiments, when emergency services pick up the SOS call, a digital assistant on smartwatch 100 begins to play an audio message from a loudspeaker on smartwatch 100 indicating that the user was in an accident. In some embodiments, the audio message is played on a loop with a predetermined number of seconds of silence between each replay. The digital assistant also relays the user's estimated location (e.g., latitude and longitude of smartwatch 100) and a search radius to emergency services. In some embodiments, the user's estimated location can be announced during the call or presented in a text message or email, and/or also announced through the loudspeaker of smartwatch 100 in case wireless communications are in operable at the accident location (e.g., no signals).

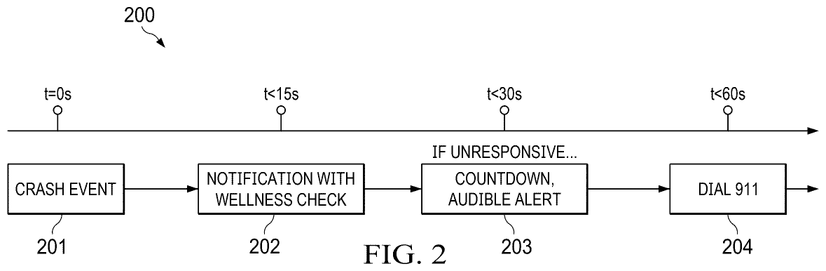

FIG. 2 is a motorcycle crash detection event timeline 200, according to one or more embodiments. At t=0 seconds the motorcycle crash event is detected 201 by smartwatch 100. At t=15 seconds a notification is presented 202 on UI 10 with a wellness check, as shown in FIG. 1. If the user is unresponsive for N seconds (e.g., N=30 seconds) after the notification is sent, a countdown is started with an audible alert 203. If after the countdown finishes there is no response from the user (e.g., no interaction with UI 101), emergency services are contacted 204 (e.g., 911 is dialed). This example timeline 200 is for illustrative purposes. Other timelines with different time limits, or different numbers and/or types of alert escalations can also be used.

### Example Crash Detection System

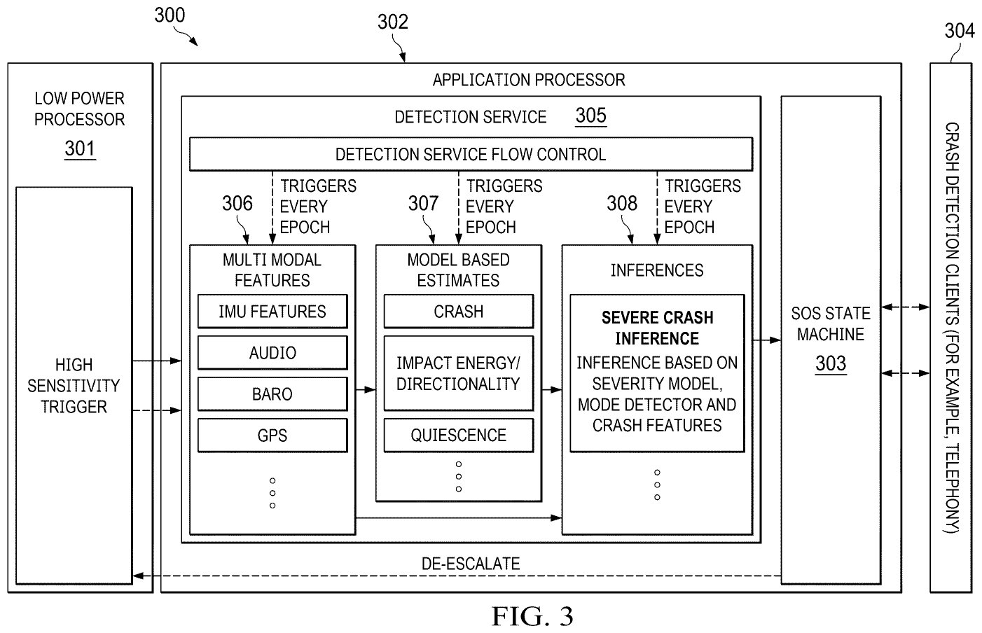

FIG. 3 is a block diagram of a crash detection system 300 for a mobile device, according to one or more embodiments. System 300 could be implemented on, for example, the smartwatch 100 shown in FIG. 1.

System 300 includes low-power processor 301, application processor 302 (also referred to herein as “always on processor” (AOP)), SOS state machine 303 and crash detection clients 304. Low-power processor 301 consumes less power than application processor 302. For at least this reason, low-power processor 301 is continuously running to detect triggers that are indicative of a motorcycle crash (hereinafter referred to as “crash event triggers”). The crash event triggers can be generated based on, for example, various observed signals from multiple sensors on the crash device. Detection service 305 running on application processor 302 monitors for crash trigger event signals sent by low-power processor 301. When a trigger event (see dashed line) is received, an epoch is started and detection service 305 extracts multimodal features 306 from sensor streams output by the sensors. For example, detection service 305 retrieves samples of sensor data from an inertial measurement unit (IMU) buffer, audio buffer and GPS buffer for every epoch. Multimodal features 306 are extracted from the buffered sensor data (e.g., acceleration, rotation rate, speed, audio snippets) and input into machine learning models 307 for generating motorcycle crash decisions. More particularly, models 307 are applied to multimodal features to generate estimates of whether a slow rollover occurred and other motorcycle crash indicators. Models 307 can implement any suitable supervised or unsupervised machine learning models, including but not limited to: regression models (e.g., linear, logistic), decision trees, random forest, support vector machines, neural networks (e.g., convolutional neural networks), classifiers, Naive Bayes, clustering, dimensionality reduction (e.g., principal component analysis (PCA)), etc.

The crash decisions output by models 307 are input into inference engine 308. Inference engine 308 uses a severity model, mode detector and crash features to infer whether a motorcycle crash has occurred. In some embodiments, inference engine 308 outputs a probability that a motorcycle crash occurred based on the crash decisions.

If the probability is above a specified threshold, a motorcycle crash is predicted and sent to SOS state machine 303, which performs UI escalation. If the escalation level rises to the level of contacting emergency services (e.g., unresponsive user after a time period/countdown), then crash clients 304 (e.g., a telephony application, messaging application, email application, digital assistant) are notified, so that emergency services and/or emergency contacts are called, as described in reference to FIGS. 1 and 2. If SOS state machine 303 de-escalates (e.g., user touches cancel affordance 103 before the time period/countdown finishes), then a de-scalation signal is relayed to low-power processor 301 to reset the trigger process.

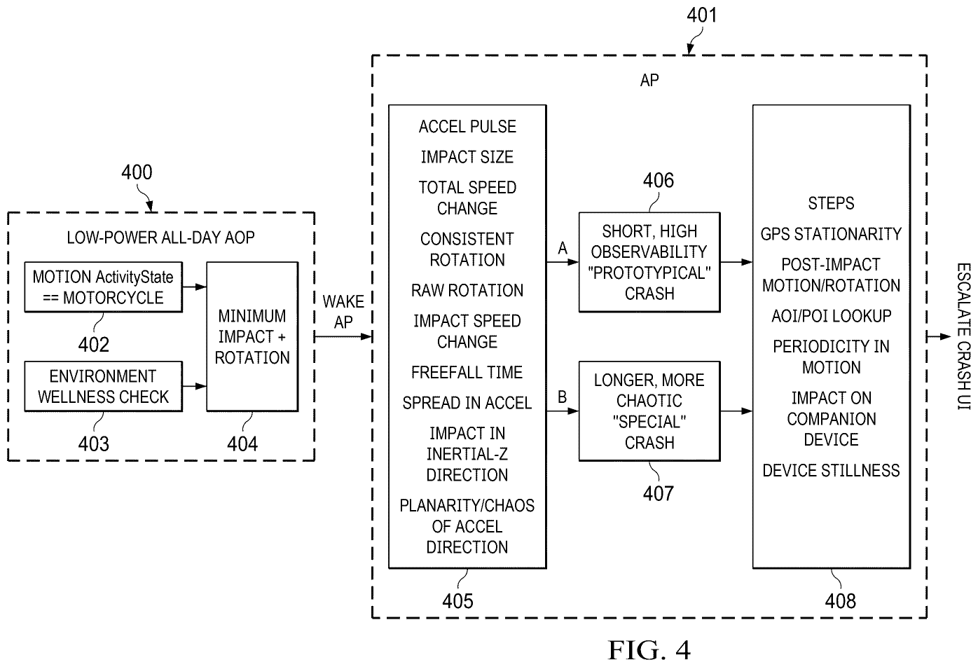

FIG. 4 is a system diagram illustrating the detection of crashes, according to one or more embodiments. System 400 includes AOP 401 and AP 402 (see also AOP 301 and AP 302 in FIG. 3). AOP 401 includes activity classifier 403, environment wellness checker 404, and trigger detector 405. All motorcycle crashes involve a change in user orientation and an impact as the rider hits the ground. To detect motorcycle crashes, a low complexity, low storage, always on processor used to detect possible motorcycle crashes and to “wake up” an application processor to compute more metrics with higher complexity. Some key indicators of a motorcycle crash include but are not limited to a consistent axis of rotation and a strong impact that occur within a few seconds of each other.

Referring to FIG. 4, activity classifier 403 determines a motional activity state of the user based on, e.g., inertial data (e.g., acceleration, rotation rate) output by inertial sensors (e.g., accelerometers, gyros), a digital pedometer that counts steps, a pressure sensor (e.g., barometer) and satellite positioning system and/or map data. Activity classifier 403 includes a state machine that transitions to a different activity state, such as in-vehicle, on motorcycle, walking and running, based on the inertial data. An example activity classifier is disclosed in U.S. Pat. No. 8,892,391 for “Activity Detection,” issued on Nov. 18, 2014.

Environment wellness checker 404 determines if the current operating context of the crash device would result in false positives, such that the activity classification output by the activity classifier 403 is unreliable.

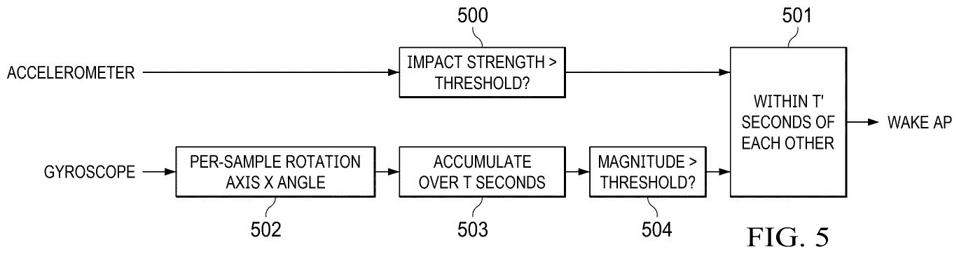

Trigger detector 405 monitors sensor data and the environment context data from the environment wellness checker 404 to detect a motorcycle crash, as described more fully in reference to FIG. 5.

After AP 402 is “woken,” AP 402 begins to process features 406, including but not limited to one or more of the following: deceleration pulse, impact size, total speed change, consistent rotation, raw rotation, impact speed change, freefall time, spread in acceleration, impact in the inertial z direction and plananity/chaos of acceleration direction. Based on features 406, AP 402 runs a classifier that infers if the motorcycle crash is a “prototypical crash” 407 (short, high observability crash typical of a vehicle) or a “special” crash 408 (longer, more chaotic crash typical of a motorcycle crash).

Depending on the type of crash (prototypical or special), AP 402 provides a number of post classification checks 409 to determine the severity of the crash, including but not limited to: step count (e.g., is the user walking), Global Navigation Satellite System (GNSS) stationarity (the crash device is not moving indicating that the user may be unconscious), post-impact motion/rotation (could indicate if the user is walking, staggering, etc.), area of interest (AOI) or point of interest (POI) lookup (e.g., is the user near a hospital), periodicity of motion (e.g., would indicate the user is walking with impairment), impact on a companion device (e.g., a smart phone), device stillness, etc. If the post classification checks 409 indicate a severe motorcycle crash, then the crash UI is escalated, as described in reference to FIG. 1.

In some embodiments, deceleration pulse and impact signatures in inertial sensor data are indicative of a motorcycle crash. For example, the deceleration and impact signatures can be characterized by sharp pulses exceeding a specified magnitude over a specified duration. In some embodiments, the deceleration pulse is a normalized average deceleration computed from horizontal components of acceleration. In some embodiments, impact is detected by a total speed change signature which is characterized by a large speed drop from a nominal speed to a lower speed over a specified duration, where the speed is computed by, e.g., a GNSS receiver. Because sometimes a rider is thrown high in the air in a motorcycle crash, in some embodiments a free fall time can be determined based on a sudden change in altitude which can be computed by detecting pressure change using a pressure sensor in the crash device. For example, a sudden increase in altitude above a nominal altitude, followed by a sudden decrease in altitude over a period of time (e.g., a few second) indicates that the rider was thrown from their motorcycle. In some embodiments, the raw instantaneous rotation rate is compared to an average rotation rate to determine if the rotation rate and rotation axis is consistent.

All or some of the crash indicators described above could be input into a machine learning model that is trained to predict or infer that a user is riding a motorcycle or a motorcycle crash.

### Example Trigger Detection

FIG. 5 is a system diagram illustrating the use of sensor data to trigger motorcycle crash detection on an application processor, according to one or more embodiments. Trigger detector 405 determines an impact value based on acceleration data. Trigger detector 405 also determines a per-sample angular rotation vector 502 from the output of a three-axis gyroscope, which is accumulated over a window of T seconds 503. A magnitude of the angular rotation vector is computed, and if the magnitude value satisfies a specified condition (e.g., exceeds a threshold value) 504, the timestamp of the magnitude is comparted with a timestamp of the impact 501. If the time of the impact and the time of the magnitude is within a specified amount of time T′ of each other (e.g., a few seconds), then “wake up” signal is sent by AOP 401 to AP 402 to “wake up” AP 402.

### Using Audio to Identify Motorcycle Crashes

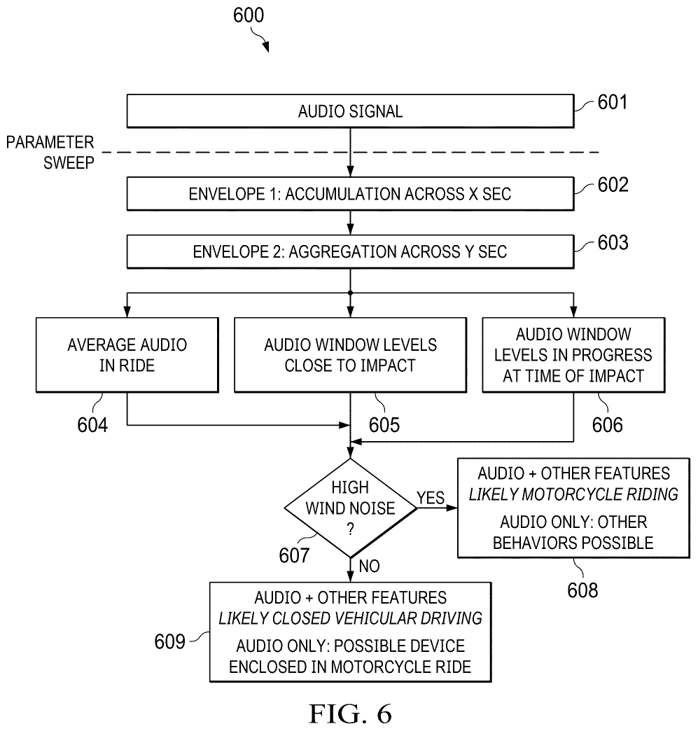

FIG. 6 is a flow diagram illustrating process 600 of using audio to identify motorcycles, according to one or more embodiments. During an open-vehicle, high-speed motion rider, wind noise can often be observed as loud audio levels detected by one or more microphones of the crash device. High audio levels can provide a cue of motorcycle riding and other activities where wind noise is present, while low audio levels can suggest closed vehicular driving.

In some embodiments, audio levels can be used to detect motorcycle riding as follows. One or more audio parameters (e.g. SPL) are extracted from an ambient audio signal captured by one or more microphones of the crash device (601) over a first time window (602). The samples are then aggregated (603) to determine an average audio level (604), audio levels prior to impact (605) and audio levels in progress at the time of impact (606.

High wind noise is detected 607 based on the audio levels 604-606. If high wind noise is detected, and there is at least one other feature indicative of motorcycle riding, then it is likely that the user is riding a motorcycle (608). If, however, high wind noise is detected and there are no other features indicative of motorcycle riding, then there is uncertainty of whether the user is riding a motorcycle. If high wind noise is not detected, and there is at least one other feature indicative of motorcycle riding, then it is likely that the user is riding inside a vehicle (609). If, however, high wind noise is not detected and there are no other features indicative of motorcycle riding, then it is possible that the crash device is in the rider's pocket or some other enclosure (e.g., motorcycle saddle bag).

### Differentiating On-Road Motorcycle Riding

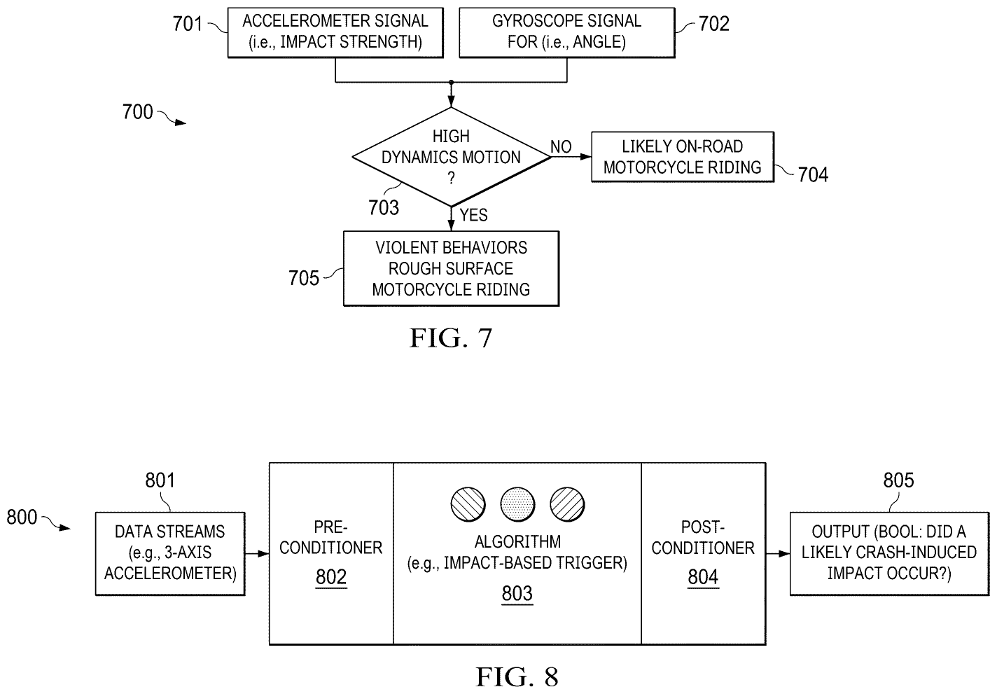

FIG. 7 is a flow diagram illustrating differentiating behaviors from on-road and other activities that have high dynamics motion, according to one or more embodiments. High dynamics motion can include observations of high rotations and multiple high impacts which are indicative a of a motorcycle crash. Differentiating these signals from sensor values in motorcycle riding can aid in conditioning models to not support certain activities with high dynamic motion if those activities are different from normal on-road motorcycle riding behavior, such as off-road motorcycle riding.

In some embodiments, acceleration vector 701 and a rotation rate vector 702 data are input into dynamic motion analyzer 703, which determines that the user is likely on-road motorcycle riding 704 or engaged in another activity with high dynamics motion 705, such as violent behaviors caused by rough surface motorcycle riding. Note that dynamic analyzer 703 uses the acceleration vector 701 to compute impact strength as described above, and the rotation rate vector to determine an angle of the acceleration vector.

In some embodiments, a maximum impact strength and maximum impact angle are determined over a first time window (e.g., a few seconds) and historically accumulated over a second time window that is longer than the first time window (e.g., a few minutes). From the data collected in the first and second time window, a continuous probability can be computed which can be used to support or not support a motorcycle crash.

### Sliding and Multi-Impact Indicators

Motorcycle crashes typically have a longer duration and more chaotic than vehicle crashes. For example, a motorcycle crash often involves “skidding” and multiple impacts. In some embodiments, sensor data is used to detect sliding of the motorcycle which would indicate a motorcycle crash. For example, when a motorcycle crashes sometimes the motorcycle will slide on the ground before during and after the crash. Sliding can be detected by estimating the roll angle (lean) of the motorcycle using inertial sensor data, such as in, for example, as described in Chuang, Tzu-Yi, Xiao-Dong Zhang, and Chih-Keng Chen. 2022. “Estimating the Roll Angle for a Two-Wheeled Single-Track Vehicle Using a Kalman Filter” Sensors 22, no. 22:8991. https://doi.org/10.3390/s22228991. If the roll angle is less than a threshold angle while the motorcycle is moving (e.g., determined based on GNSS speed), then it can be inferred that the motorcycle is sliding on the ground, and thus an indicator of a motorcycle crash. Also, a spread in deceleration events in the z axis (direction of gravity) overtime (e.g., separated by a few seconds) is indicative of multiple impacts with the ground which also occurs often in motorcycle crashes.

In some embodiments, the algorithms for computing the various features for detecting motorcycle crashes are monitored to ensure that the algorithms stay withing mathematical specifications or limits to ensure the integrity of the data output by the algorithms.

FIG. 8 is a flow diagram illustrating a self-monitoring process 800 for motorcycle crash detection algorithms/models, according to one or more embodiments. An algorithm or model should respond in a robust and predictable manner to an environment or sensor stream input(s) that the process was not otherwise designed or validated against. Self-monitoring process 800 was designed to facilitate this goal.

Process 800 includes pre-conditioner 802, algorithm/model 803, post-conditioner 804 and output 805. In some embodiments process 800: 1) is evaluating the algorithm/model and has determined that the algorithm/model 802 is operating outside of the boundary conditions and/or assumptions of the algorithm/model; 2) is evaluating the algorithm/model but is undecided on current boundary conditions of the algorithm/model; and 3) is evaluating the algorithm/model and has determined that the algorithm/model is operating within its boundary conditions/assumptions.

Pre-conditioner 801 calculates metrics based on the input data streams to meet the algorithm designed boundary conditions (e.g., variance of accelerometer is low). Post-conditioner 804 determines metrics based on the output data stream meeting the expected performance targets (e.g., low number of detected impacts per hour). In some embodiments, output 805 of process 800 is data (e.g., Boolean value) indicating whether a likely crash induced impact has occurred. Output 805 can be used by the motorcycle crash detection system 300 to determine whether to perform a UI escalation. For example, if process 800 indicates that a crash detection algorithm is operating outside of its design space, then the motorcycle crash detection system 300 may not perform UI escalation as the crash detection algorithm output may not be accurate.

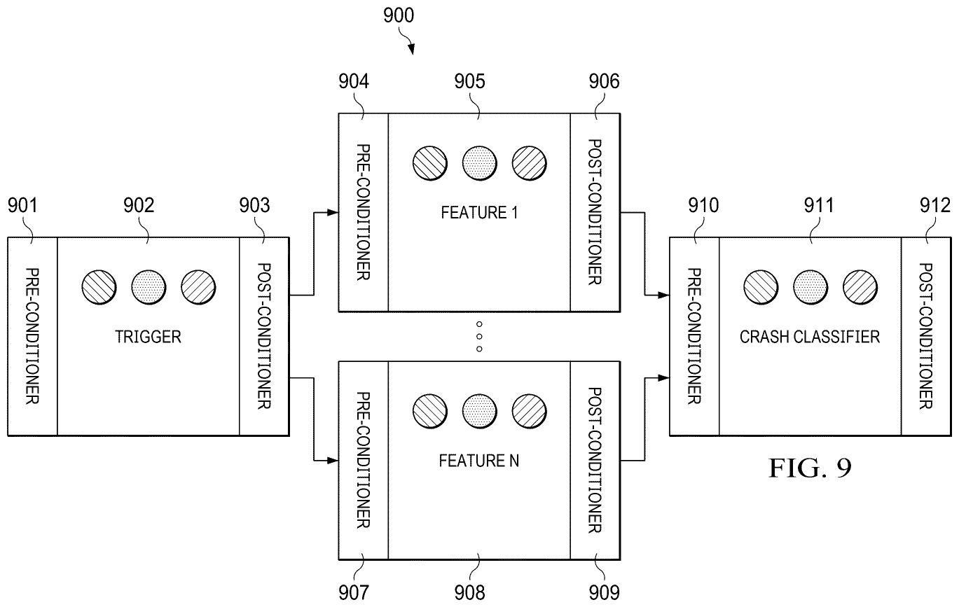

FIG. 9 is a flow diagram illustrating cascaded process 900 behavior, according to one or more embodiments. Pre-conditioner 901 and post-conditioner 903 operate as indicated in reference to FIG. 8 for trigger 902. Output of post-conditioner 903 is input pre-conditioner 903 of Feature 905 (Feature 1) and pre-conditioner 907 of Feature 908 (Feature N), where Features 1 . . . N are input into classifier 911. The outputs of post-conditioner 906 of Feature 905 and the output of post-conditioner 909 of Feature 908 are input into pre-conditioner 910 of classifier 911. Post-conditioner 912 provides output the indicates the reliability of classifier output.

As shown in FIG. 9, downstream algorithms (e.g., classifier 911) interpret and adapt behavior based on upstream algorithms, such as trigger 902. For example, if post-conditioner 903 indicates that trigger 902 is operating outside of its boundary conditions/assumptions, Feature 905 may choose to ignore the output of post-conditioner 903. Alternatively, classifier 911 may choose to ignore Feature 905 if post-conditioner indicates that boundary conditions/assumptions have been violated by trigger 902.

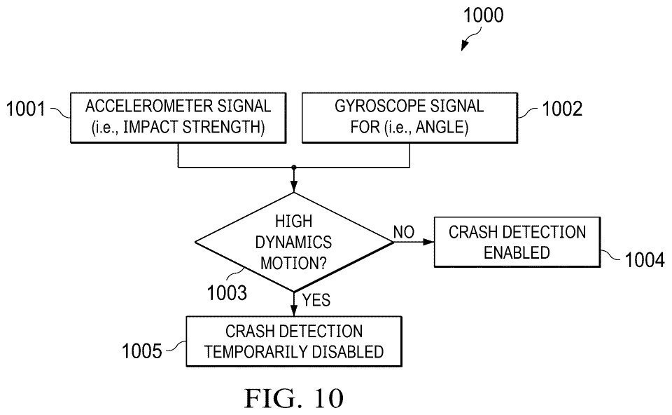

FIG. 10 is a flow diagram illustrating a process self-monitoring for motorcycle crash detection, according to one or more embodiments. Process 1000 includes high dynamics motion detector 1003 which takes as input an accelerometer signal 1001 and gyroscope signal 1012 and outputs crash detection enabled 1004 or crash detection temporarily disable 1005. In this example, the objective of self-monitoring is to determine when the motorcycle crash detection is supported in the current environment. The crash detection algorithm assumption is that a typical motorcycle ride should have infrequent impacts and rotations. Accordingly, the crash detection algorithm is designed for infrequent impacts and rotations. If boundary conditions or assumptions are not met as determined by self-monitoring system 800, crash detection can be temporarily disabled or modified.

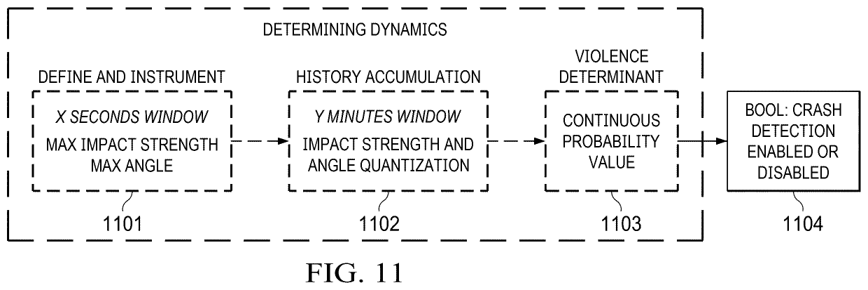

FIG. 11 is a flow diagram illustrating a process 1100 of process self-monitoring for motorcycle crash detection, according to one or more embodiments. In the example show, dynamics are determined over two time windows of different duration. In a first time window, the maximum impact strength and maximum angle are computed 1101. In a second window longer than the first window, historical impact strength and angle quantization 1102 are accumulated. The contents are of the second window are used to determine a continuous probability value 1103 that indicates violent dynamics. Based on the continuous probability value, crash detection is enabled or disabled. For example, if the accumulation of impact strength and angle indicate a high continuous probability that the user is operating the motorcycle on paved road, then crash detection is enabled, as opposed to determining, based on high dynamics, that the user is operating the motorcycle on a dirt road (e.g., dirt bike riding). Process 1100 therefor lowers the risk of a false positive crash detection when the user is riding offroad and therefore subject to higher dynamics and numbers of impacts detected.

### Example Process

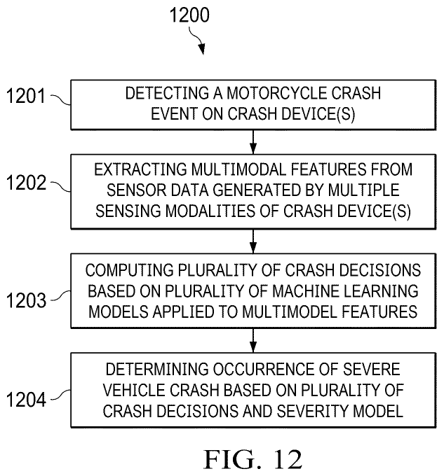

FIG. 12 is a flow diagram of a process 1200 for motorcycle crash detection, as described in reference to FIGS. 1-11. Process 1200 includes the steps of: detecting a motorcycle crash event on a crash device (1201); extracting multimodal features from sensor data generated by multiple sensing modalities of the crash device (1202); computing a plurality of crash decisions based on a plurality of machine learning models applied to the multimodal features (1203); and determining that a motorcycle crash has occurred involving the crash device based on the plurality of crash decisions and a severity model (1204). Each of these steps were previously described in detail in reference to FIGS. 1-11.

### Example Device Architecture

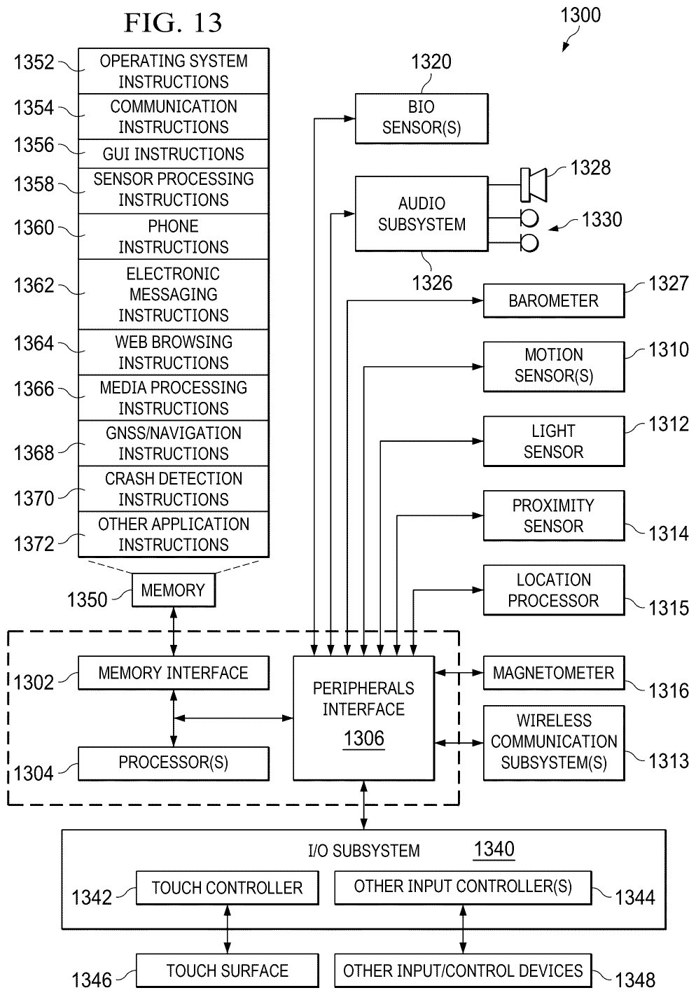

FIG. 13 is a block diagram of a crash device architecture 1300 for implementing the features and processes described in reference to FIGS. 1-12. Architecture 1300 can include memory interface 1302, one or more hardware data processors, image processors and/or processors 1304 and peripherals interface 1306. Memory interface 1302, one or more processors 1304 and/or peripherals interface 1306 can be separate components or can be integrated in one or more integrated circuits. System architecture 1300 can be included in any suitable electronic device for crash detection, including but not limited to: a smartwatch, smartphone, fitness band and any other device that can be attached, worn, or held by a user.

Sensors, devices, and subsystems can be coupled to peripherals interface 1306 to provide multiple functionalities. For example, one or more motion sensors 1310, light sensor 1312 and proximity sensor 1314 can be coupled to peripherals interface 1306 to facilitate motion sensing (e.g., acceleration, rotation rates), lighting and proximity functions of the wearable device. Location processor 1315 can be connected to peripherals interface 1306 to provide geo-positioning. In some implementations, location processor 1315 can be a GNSS receiver, such as the Global Positioning System (GPS) receiver. Electronic magnetometer 1316 (e.g., an integrated circuit chip) can also be connected to peripherals interface 1306 to provide data that can be used to determine the direction of magnetic North. Electronic magnetometer 1316 can provide data to an electronic compass application. Motion sensor(s) 1310 can include one or more accelerometers and/or gyros configured to determine change of speed and direction of movement. Barometer 1317 can be configured to measure atmospheric pressure (e.g., pressure change inside a vehicle). Bio signal sensor 1320 can be one or more of a PPG sensor, an electroencephalogram (EEG) sensor, an electrocardiogram (ECG) sensor, an electromyogram (EMG) sensor, a mechanomyogram (MMG) sensor (e.g., piezo resistive sensor) for measuring muscle activity/contractions, an electrooculography (EOG) sensor, a galvanic skin response (GSR) sensor, a magnetoencephalogram (MEG) sensor and/or other suitable sensor(s) configured to measure bio signals.

Communication functions can be facilitated through wireless communication subsystems 1324, which can include radio frequency (RF) receivers and transmitters (or transceivers) and/or optical (e.g., infrared) receivers and transmitters. The specific design and implementation of the communication subsystem 1324 can depend on the communication network(s) over which a mobile device is intended to operate. For example, architecture 1300 can include communication subsystems 1324 designed to operate over a GSM network, a GPRS network, an EDGE network, a WiFi™ network and a Bluetooth™ network. In particular, the wireless communication subsystems 1324 can include hosting protocols, such that the crash device can be configured as a base station for other wireless devices.

Audio subsystem 1326 can be coupled to a speaker 1328 and a microphone 1330 to facilitate voice-enabled functions, such as voice recognition, voice replication, digital recording, and telephony functions. Audio subsystem 1326 can be configured to receive voice commands from the user. Audio subsystem 1326 can be used to capture audio during a crash and to convert the audio to SPL for crash detection processing.

I/O subsystem 1340 can include touch surface controller 1342 and/or other input controller(s) 1344. Touch surface controller 1342 can be coupled to a touch surface 1346. Touch surface 1346 and touch surface controller 1342 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch surface 1346. Touch surface 1346 can include, for example, a touch screen or the digital crown of a smart watch. I/O subsystem 1340 can include a haptic engine or device for providing haptic feedback (e.g., vibration) in response to commands from processor 1304. In an embodiment, touch surface 1346 can be a pressure-sensitive surface.

Other input controller(s) 1344 can be coupled to other input/control devices 1348, such as one or more buttons, rocker switches, thumbwheel, infrared port, and USB port. The one or more buttons (not shown) can include an up/down button for volume control of speaker 1328 and/or microphone 1330. Touch surface 1346 or other controllers 1344 (e.g., a button) can include, or be coupled to, fingerprint identification circuitry for use with a fingerprint authentication application to authenticate a user based on their fingerprint(s).

In one implementation, a pressing of the button for a first duration may disengage a lock of the touch surface 1346; and a pressing of the button for a second duration that is longer than the first duration may turn power to the mobile device on or off. The user may be able to customize a functionality of one or more of the buttons. The touch surface 1346 can, for example, also be used to implement virtual or soft buttons.

In some implementations, the mobile device can present recorded audio and/or video files, such as MP3, AAC and MPEG files. In some implementations, the mobile device can include the functionality of an MP3 player. Other input/output and control devices can also be used.

Memory interface 1302 can be coupled to memory 1350. Memory 1350 can include high-speed random-access memory and/or non-volatile memory, such as one or more magnetic disk storage devices, one or more optical storage devices and/or flash memory (e.g., NAND, NOR). Memory 1350 can store operating system 1352, such as the iOS operating system developed by Apple Inc. of Cupertino, California. Operating system 1352 may include instructions for handling basic system services and for performing hardware dependent tasks. In some implementations, operating system 1352 can include a kernel (e.g., UNIX kernel).

Memory 1350 may also store communication instructions 1354 to facilitate communicating with one or more additional devices, one or more computers and/or one or more servers, such as, for example, instructions for implementing a software stack for wired or wireless communications with other devices. Memory 1350 may include graphical user interface instructions 1356 to facilitate graphic user interface processing; sensor processing instructions 1358 to facilitate sensor-related processing and functions; phone instructions 1360 to facilitate phone-related processes and functions; electronic messaging instructions 1362 to facilitate electronic-messaging related processes and functions; web browsing instructions 1364 to facilitate web browsing-related processes and functions; media processing instructions 1366 to facilitate media processing-related processes and functions; GNSS/Location instructions 1368 to facilitate generic GNSS and location-related processes and instructions; and crash detection instructions 1370 that implement the motorcycle crash detection processes described in reference to FIGS. 1-12. Memory 1350 further includes other application instructions 1372 including but not limited to instructions for applications that utilize motorcycle crash detection output.

Each of the above identified instructions and applications can correspond to a set of instructions for performing one or more functions described above. These instructions need not be implemented as separate software programs, procedures, or modules. Memory 1350 can include additional instructions or fewer instructions. Furthermore, various functions of the mobile device may be implemented in hardware and/or in software, including in one or more signal processing and/or application specific integrated circuits.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As described above, some aspects of the subject matter of this specification include gathering and use of data available from various sources to improve services a mobile device can provide to a user. The present disclosure contemplates that in some instances, this gathered data may identify a particular location or an address based on device usage. Such personal information data can include location-based data, addresses, subscriber account identifiers, or other identifying information.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

In the case of advertisement delivery services, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

What is claimed is:

1. A method comprising:
detecting, with at least one processor, a motorcycle crash event on a crash device;
extracting, with the at least one processor, multimodal features from sensor data generated by multiple sensing modalities of the crash device;
computing, with the at least one processor, a plurality of crash decisions based on a plurality of machine learning models applied to the multimodal features; and
determining, with the at least one processor, that a motorcycle crash has occurred involving the crash device based on the plurality of crash decisions and a severity model.

2. The method of claim 1, further comprising:
responsive to a severe crash being determined, presenting a notification on a screen of the crash device requesting a response from a user of the crash device.

3. The method of claim 2, further comprising:
determining whether the crash device is stationary for a predetermined period of time;
responsive to the crash device being stationary for the predetermined period of time,
starting a timer or counter;
determining that the timer or counter meets a threshold time or count, respectively; and
escalating the notification.

4. The method of claim 3, further comprising:
determining, as a result of the escalating, that no response to the notification was received after the threshold time or count was met, automatically contacting emergency services using one or more communication modalities of the crash device.

5. The method of claim 1, further comprising:
sending, to a network server computer, at least one of the multimodal features, crash decisions, inference of a severe crash or user interactions with the notification;
receiving, from the network server, at least one update to at least one parameter of at least one machine learning model or the severity model; and
updating, with the at least one processor, the at least one parameter with the at least one update.

6. The method of claim 1, wherein at least one of the multimodal features is user orientation data captured by at least one rotation sensor of the crash device.

7. The method of claim 1, wherein at least one of the multimodal features is impact data as the user hits the ground captured by at least one accelerometer of the crash device.

8. The method of claim 1, wherein at least one of the multimodal features is a deceleration pulse signature present in acceleration data.

9. The method of claim 1, wherein at least one of the multimodal features is sound pressure level of audio data captured by at least one microphone of the crash device.

10. The method of claim 1, wherein at least one of the multimodal features is a drop in speed of the crash device.

11. The method of claim 1, wherein the at least two multimodal features are processed over two different time windows having different time lengths.

12. The method of claim 1, wherein the method further comprises detecting a motorcycle crash event on a crash device includes distinguishing between a vehicle crash and a motorcycle crash based on a level of ambient audio captured by a microphone of the crash device.

13. The method of claim 12, wherein a level of wind noise in the ambient audio and at least one other crash detection feature are used to distinguish between the vehicle crash and the motorcycle crash.

14. The method of claim 1, further comprises detecting a motorcycle crash event on a crash device includes distinguishing between on-road and off-road motorcycle riding.

15. The method of claim 1, further comprising:
receiving, with the at least one processor, crash related features from a companion device coupled to the crash device;
computing, with the at least one processor, a plurality of crash decisions based on a plurality of machine learning models applied to the multimodal features and crash related features; and
inferring, with the at least one processor, that a severe vehicle crash has occurred involving the crash device based on the plurality of crash decisions and a severity model.

16. The method of claim 1, further comprising:
matching epochs for the multimodal features with epochs for the additional multimodal features to remove misalignment between epoch boundaries.

17. A system comprising:
at least one motion sensor;
at least one processor;
memory storing instructions that when executed by the at least one processor, cause the at least one processor to perform operations comprising:
detecting a motorcycle crash event based at least in part on sensor data from the at least one motion sensor;
extracting multimodal features from sensor data generated by multiple sensing modalities of the apparatus;
computing a plurality of crash decisions based on a plurality of machine learning models applied to the multimodal features; and
inferring that a motorcycle crash has occurred involving the apparatus based on the plurality of crash decisions and a severity model.

18. The system of claim 17, further comprising:
responsive to a motorcycle crash being determined, presenting a notification on a screen of the crash device requesting a response from a user of the apparatus.

19. The system of claim 18, further comprising:
determining a stationarity of the apparatus;
starting a time or counter;
determining that the timer or counter meets a threshold time or count, respectively; and
presenting the notification on the screen of the apparatus requesting a response from a user of the apparatus.

20. The system of claim 19, further comprising:
determining that no response to the notification was received from the user; and
automatically contacting emergency services using one or more communication modalities of the apparatus.

21. The system of claim 17, further comprising:
sending, to a network server computer, at least one of the multimodal features, crash decisions, inference of a severe crash or user interactions with the notification;
receiving, from the network server, at least one update to at least one parameter of at least one machine learning model or the severity model; and
updating, with the at least one processor, the at least one parameter with the at least one update.

22. The system of claim 17, wherein at least one of the multimodal features is user orientation data captured by at least one rotation sensor of the crash device.

23. The system of claim 17, wherein at least one of the multimodal features is impact data as the user hits the ground captured by at least one accelerometer of the crash device.

24. The system of claim 17, wherein at least one of the multimodal features is a deceleration pulse signature present in acceleration data.

25. The system of claim 17, wherein at least one of the multimodal features is sound pressure level of audio data captured by at least one microphone of the crash device.

26. The system of claim 17, wherein at least one of the multimodal features is a drop in speed of the crash device.

27. The system of claim 17, wherein the at least two multimodal features are processed over two different time windows having different time lengths.

28. The system of claim 17, wherein the method further comprises detecting a motorcycle crash event on a crash device includes distinguishing between a vehicle crash and a motorcycle crash based on a level of ambient audio captured by a microphone of the crash device.

29. The system of claim 28, wherein a level of wind noise in the ambient audio and at least one other crash detection feature are used to distinguish between the vehicle crash and the motorcycle crash.

30. The system of claim 17, further comprises detecting a motorcycle crash event on a crash device includes distinguishing between on-road and off-road motorcycle riding.

31. The system of claim 17, further comprising:
receiving, with the at least one processor, crash related features from a companion device coupled to the crash device;
computing, with the at least one processor, a plurality of crash decisions based on a plurality of machine learning models applied to the multimodal features and crash related features; and
inferring, with the at least one processor, that a severe vehicle crash has occurred involving the crash device based on the plurality of crash decisions and a severity model.

32. The system of claim 17, further comprising:
matching epochs for the multimodal features with epochs for the additional multimodal features to remove misalignment between epoch boundaries.
